(19) United States
(12) Patent Application Publication
(10) Pub. No.: US 2003/0223003 A1
(43) Pub. Date: Dec. 4, 2003

(54) Fast and low-power multiplexing circuit and use thereof in imaging devices

(76) Inventor: Guy Meynants, Retie (BE)

Correspondence Address: Lee, Mann, Smith, McWilliams, Sweeney & Ohlson, P.O. Box 2786, Chicago, IL, 60690-2786, US

(21) Appl. No.: 10/103,011

(22) Filed: Mar. 21, 2002

(51) Int. Cl. H04N 5/335

(52) U.S. Cl. 348/294

(57) ABSTRACT

A multiplexing circuit for use in imaging devices is described comprising a series of signal input nodes, a series of first memory elements for storing a signal level on the corresponding signal input nodes and at least a first output node comprising a second memory element. A series of first switching elements is provided, each first switching element being connected to a first memory element on one side and a first output node on the other side, and a second switching element is provided to bring the first output node in a known state. The readout requires less energy consumption than known methods using amplifiers. The signal levels stored on the first memory elements may be outputs from pixels which may be formed in an array of columns and rows. The signal levels from different pixels may be combined together to improve signal to noise ratios.

### FIELD OF THE INVENTION

The present invention relates to solid state imaging devices and pixel arrays being manufactured in a CMOS- or MOS-technology and methods of operating the same. More particularly, a multiplexing circuit for fast and low-power multiplexing of pixel or column signals to (one or more) common signal collecting node(s) is disclosed as well as methods of operating the same.

### DESCRIPTION OF RELATED TECHNOLOGIES

Solid state image sensors are well known. Commonly, solid state image sensors are implemented in a CCD technology or in a CMOS- or MOS-technology. Solid state image sensors find widespread use in camera systems. A matrix of pixels comprising light sensitive elements constitutes an image sensor, which is mounted in the camera system. The signal of said matrix is measured and multiplexed to a so-called video signal. In other embodiments, the solid state image sensor constitutes of only one row of pixels which is multiplexed to an output signal.

In any case, the signal of each pixel needs to be directed towards an output node through a multiplexing scheme. In Charge-Coupled Devices or CCDs, the multiplexing is obtained by charge shifting to an output node wherein the charge is converted into a voltage output signal. In CMOS- or MOS-based sensors, the signal is first transferred to the columns, and then from the columns to the output node through a set of amplifiers and switches that drive an output bus. This is shown schematically in FIG. 1 in which OS based pixels 1 are arranged in an array having rows and columns. Four column readout lines 2 are shown connected to the pixels 1 via a selecting device 7. In each column line 2 there is at least one amplifier 3 and one switch 4. These amplifiers 3 are power-consuming and determine the maximal readout speed of the image sensor. The switches 4 are connected to at least one output line 5 and an amplifier 6.

### SUMMARY OF THE INVENTION

The present invention has as one of its aims to reduce the power requirements for this multiplexing, and meanwhile maintain a high readout speed.

One of the key signal processing steps of CMOS or MOS image sensors is elimination of the offset variations between different pixels. A further object of the present invention, in some of its embodiments, is to provide a circuit which is able to do an effective correction of these offset variations.

Yet a further objet of the present invention is to provide a circuit which is fast in operation and provides low power multiplexing of signals on a readout bus.

At least some of the objects of the present invention are achieved by charge sharing between the capacitance of a signal storage node and the capacitance of a readout node. Signals to be multiplexed are stored as charges on a signal storage node. For readout of one of such nodes, the readout node is first reset to a known level (Vref) and then the readout node and the storage node are connected together. At this moment, the charge on the signal node is redistributed or shared between the readout node and the storage node.

A multiplexing circuit in accordance with embodiments of the present invention can be inherently low power consuming. Only the power necessary to charge the storage node is consumed. The multiplexing circuit may also be fast. The only time limitation is set by the time constant of the RC circuit formed by the capacitors and the series resistance of any switch that connects them. This time constant is anyhow present in any multiplexing scheme, and this multiplexing is linear.

Particularly in image sensors, this multiplexing circuit can be combined with offset correction techniques wherein successive samples of a pixel in different states or after different integration times are taken, and wherein the difference between said samples is calculated in order to eliminate fixed pattern noise or to enhance image quality.

In other implementations, the multiplexing circuit can also provide an averaging of different signals on the readout bus. This offers an effective way of exchanging image resolution for readout noise of pixels.

Accordingly the present invention provides a multiplexing circuit comprising:

a series of signal input nodes

a series of first memory elements for storing a signal level on the corresponding signal input nodes

at least a first output node comprising a second memory element

a series of first switching elements, each first switching element being connected to a first memory element on one side and a first output node on the other side, and

a second switching element to bring the first output node in a known state. The readout requires less energy consumption than known methods using amplifiers. The signal levels stored on the first memory elements may be outputs from pixels which may be formed in an array, e.g. of columns and rows. The pixels may be active pixels. The signal levels from different pixels may be combined together before being output to improve signal to noise ratios. The first switching elements can have an open and closed state and in the closed state the first switching elements share a charge stored in the corresponding first memory element with the second memory element. The multiplexing circuit may also have an output amplifying element and an input to the amplifying element is connected to a common point between the first and second memory elements. The output amplifying element may be a transistor. At least one of the first and second memory elements can be a capacitor. The first and second switching elements usually have open and closed states and a timing circuit provides timing signals to the first and second switching elements to switch each first and second switching element to an open or closed state, and the timing circuit is adapted to drive the first and second switching elements so that a first switching element is not closed at the same time as a second switching element is closed. The multiplexing circuit may comprise two output nodes, the second output node being connected to a third memory element and a third switching element to bring the second output node in a known state, and each input signal node comprising the first and a fourth memory element, a fourth switching element being connected to the fourth memory element on one side and the second output node on the other side.

A first signal may be stored in the first memory element, a second signal is stored ill the second memory element, and a timing circuit drives the first to fourth switching elements such that the charge on the first memory element is shared with the second memory element, the charge on the fourth memory is shared with the third memory element, the second switching element brings the first output node in the known state and a third switching element brings the second output node in a known state. In this case the first and second outputs nodes can be connected to inputs of an amplifying element.

A pixel and readout circuitry therefor adapted for integration in an imaging device, comprising

a radiation sensitive element able to produce an electrical signal indicative of the amount of radiation picked up by that pixel,

a signal input node, a signal level being obtained from the radiation sensitive element,

a first memory element for storing the signal level on the corresponding signal input node

at least a first output node comprising a second memory element

a first switching element being connected to the first memory element on one side and the first output node on the other side, and

a second switching element to bring the first output node in a known state.

The present invention also provides an array of pixels for integration in an imaging device, each pixel comprising a radiation sensitive element able to produce an electrical signal indicative of the amount of radiation picked up by that pixel, further comprising:

a signal input node, a signal level being obtained from the radiation sensitive element,

a first memory element for storing the signal level on the corresponding signal input node

at least a first output node comprising a second memory element

a first switching element being connected to the first memory element on one side and the first output node on the other side, and

a second switching element to bring the first output node in a known state. The pixels may be arranged in rows and columns and means for combining the signal levels from a plurality of pixels may be provided. The pixels may be active pixels.

The present invention also provides a method for reading out a solid state imaging device having a group of pixels, each pixel comprising a radiation sensitive element, the method comprising the following steps:

reading out the signal of a pixel brought in a first state and storing the corresponding charge in a first memory element

bring the output line into a reference state

sharing the charge on the first memory element with a second memory element on an output line, and

repeating these steps for at least part of the pixels of the imaging device. The pixels may be active pixels. The readout may be modified so that a combination of signals from several pixels is output.

The present invention will now be described with reference to the following schematic drawings.

### BRIEF DESCRIPTION OF THE DRAWINGS

In the following drawings the same reference numerals in different drawings refer to elements with the same or similar function except where specifically stated.

FIG. 1 shows a commonly used architecture for MOS image sensors with signal multiplexing through amplifiers.

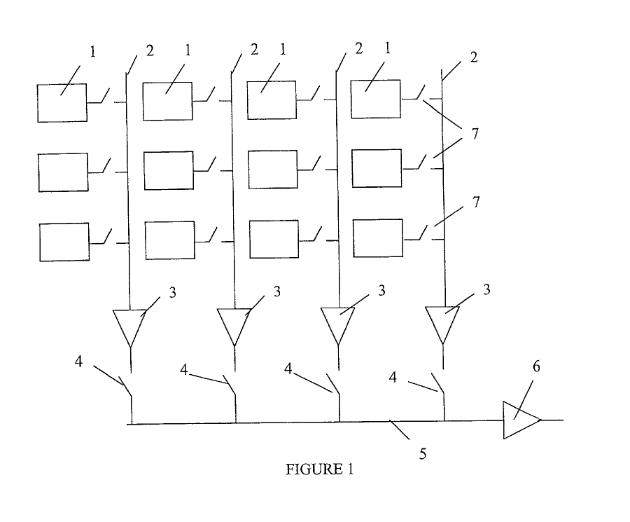

FIG. 2 shows an embodiment of a multiplexing circuit as well as a timing of the switches for fast and low power multiplexing in accordance with the present invention in which

$${V}_{out} = \frac{{C}_{s}}{{C}_{s} + {C}_{bus}} {V}_{i n} .$$

FIG. 3 shows an embodiment of a fast and low-power multiplexing circuit combined with offset correction circuitry that eliminates offset variations of the column inputs.

FIG. 4 shows an embodiment of an output amplifier to generate a single-ended output.

FIG. 5 shows an embodiment of an output amplifier stage for generation of single-ended signal output. Reset and Signal bus are de-phased. A series capacitor in the output stage subtracts the reset level from the signal level.

FIG. 6 shows an embodiment of the present invention with differential outputs.

FIG. 7 shows a further embodiment of the present invention with differerential outputs.

FIG. 8 shows an embodiment of an output readout stage with capacitive calculation of difference between R and S. In this example the signal on the output bus after pulsing (Φ1, Φ2 and Φ3 is ⅔*Vdd+(VS-VR)/3 if CR=CB=2*CS.

FIG. 9 shows a timing diagram of pseudo-binning in accordance with an embodiment of the present invention. Samples Vin1 and Vin2 are binned.

FIG. 10 shows an example of an active pixel containing three transistors and a photodiode that can be used in the present invention.

FIG. 11 shows an embodiment of the device for imaging applications according to the present invention.

### DETAILED DESCRIPTION OF THE INVENTION

The present invention will be described with reference to certain embodiments and drawings but the skilled person will appreciate that these are examples of the invention and are therefore not necessarily limiting on the concepts detailed in the attached claims.

1. Basic Circuit

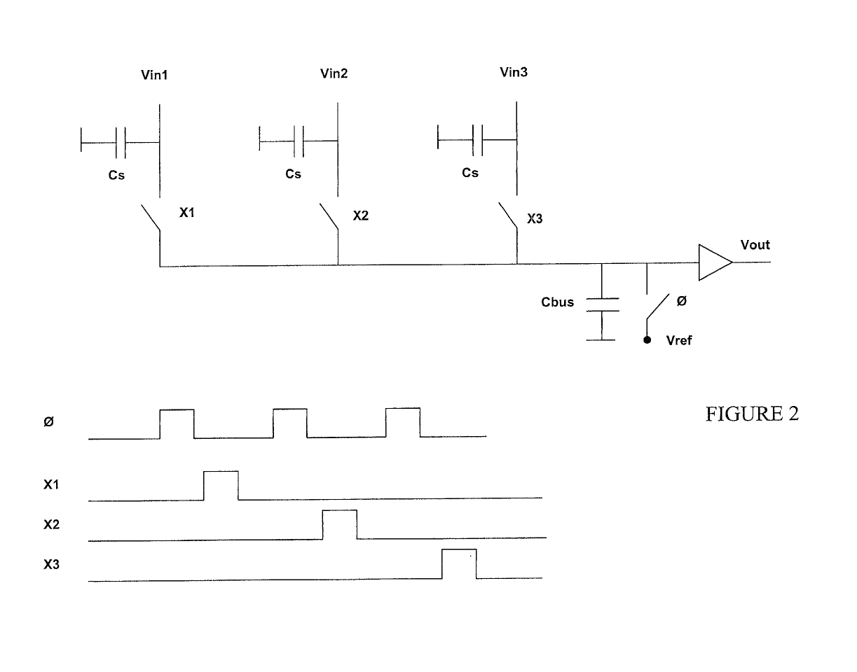

A multiplexing circuit in accordance with a first embodiment is essentially built from five different elements and is shown schematically FIG. 2:

1) column signal input lines (Vin1, Vin2 . . .

2) charge storage nodes (“Cs”) that store the signals to be multiplexed, for example the charge storage nodes may be any suitable memory element such as a capacitor;

3) a charge readout node (“Cbus”) whereon the multiplexed signals appear;

4) first switching means (“X1”, “X2”, . . . ) that connect the storage node to the readout node for multiplexing;

5) a second switching means (“Φ”) to bring the readout node in a known reference state, e.g. by connecting the readout node to a voltage reference Vref.

The multiplexing (as shown in FIG. 2) is done in 2 steps: first the readout node is brought into a known state (with a known number of charges stored on this node) by closing switch “Φ” (phi) and connecting the readout node to a reference, e.g. a reference voltage; then the charges of the storage node and readout node (if charges are present there) are redistributed by connecting both nodes together (through switching means “Xn”). The signal on the readout node can be read out after this redistribution. It is important that the operation of switches “Φ” (phi) and “Xn” do not overlap so that both are in a closed (conducting) state at the same time.

If the capacitance value of the signal storage node is called Cs, and the capacitance value of the readout node is called Cbus, the circuit has a gain of Cs/(Cs+Cbus). The voltage signal is thus attenuated. If the storage node capacitor Cs is equal to the bus capacitance (Cbus), the signal gain is 0.5. The signal gain increases when the storage node capacitor is larger. In practical use, the bus capacitance needs to be designed as low as possible and the sampling capacitor needs to be as large as possible, but a significant attenuation can not be avoided due to physical limitations of the capacitor sizes. The signal attenuation can be tolerated because also the noise is attenuated, while no additional noise is generated. The S/N of the output signal is thus equal to the S/N of the inputs. The circuit is also inherently linear if the capacitance values are not dependent on the signal levels.

The multiplexing is fast and only determined by the RC time constant of the switching means and the readout node. Typical values are 5 KOhms for the on-resistance of a switch and 2 pF for the capacitance of the bus, yielding an RC time constant of 1 ns. After 5 ns, the signal has reached 99% of its final value. Another 5 ns are necessary for resetting the bus before the multiplexing (Ø(theta) closed in FIG. 2). This means the multiplexing of one signal on the bus takes 10 ns in total, which corresponds to 100 MHz readout rate.

The energy consumption for multiplexing with this technique is the minimal theoretical value achievable for multiplexing voltages. For a signal with an amplitude “V” at the input, the consumed energy is only the necessary energy to charge the storage node capacitor (i.e.: E=Cs*V\hat{ }2) and to precharge the multiplexer bus when Ø is closed (E=Cbus* Vref\hat{ }2). When the multiplexer switch is closed, it does not introduce any more power consumption, the only effect is a charge redistribution which does not consume energy. The total energy consumption per sample is thus Cs*V\hat{ }2+Cbus*Vref\hat{ }2.

2. Multiple Sampling for Differential Readout and/or Cancellation of Offset Variations

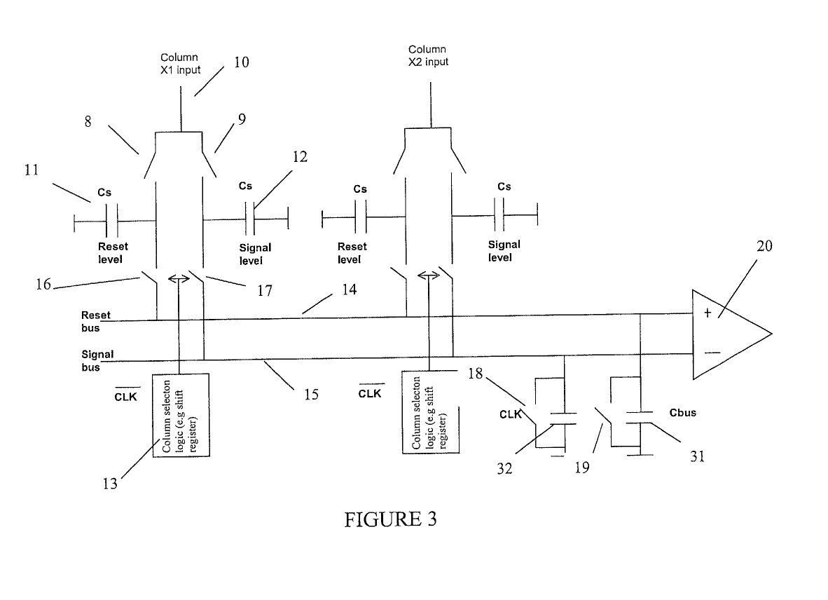

The multiplexing circuit of the above embodiment can be combined with multiple sampling operations, wherein correlated or related samples of a signal are taken and stored on different charge storage nodes, and wherein each of these nodes is read out through one or more busses 14, 15. FIG. 3 shows a particular implementation of such a circuit. One signal from a line 10 (corresponding to the “reset” state of the signal of interest) is applied on one memory element, e.g. a capacitor 11 via a switching element 8, and a second signal from the line 10 (corresponding to the “signal” state of the signal of interest) is applied on a second memory element, e.g. capacitor 12 via a switching means 9. For readout of the signals, two busses 14, 15 are reset to a known voltage during the first half of the clock period (with CLK high) by a timing circuit which supplies signals to close switches 18 19 which connects the busses 14, 15 to a reference voltage. During the second half of the clock period (when CLK is low), a timing circuit such as a column selection logic 13 supplies signals to close the switches 16, 17 in the columns and puts the stored signals on both busses 14, 15 (called “reset bus” and “signal bus”). The charge on capacitors 11, 12 is shared with capacitors 31, 32 each having a capacitance Cbus. The signals on the busses are amplified by a differential input amplifier 20. The difference between the signals on the two busses 14, 15 at this moment is a measure of the signal of interest, and free of any common-mode offset variations that occur between the signals. This is especially useful in image sensors wherein random offset variations occur between the signals of different pixels. The difference between the reset signal of a pixel and the signal of a pixel after integration of light is free of pixel offsets. There are also no new offsets introduced in the column circuitry. The offset-free signal obtained in this way can directly be displayed, without need for further corrections.

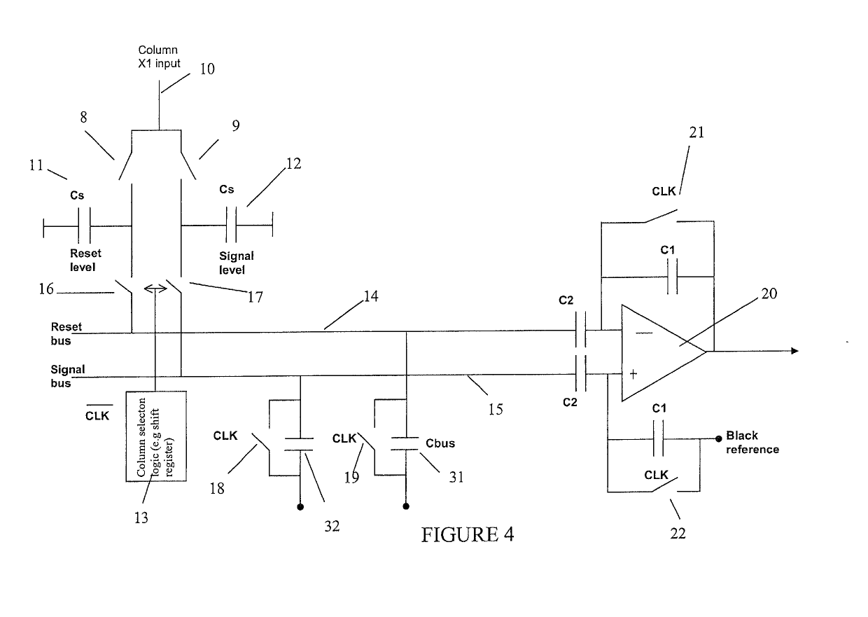

FIG. 4 shows a further embodiment of the present invention wherein a single-ended output is generated at an amplifier 20 from the differential signal between the signals on the busses 14, 15. The amplifier 20 amplifies the difference between the signals on both busses 14, 15. This amplifier 20 has to work at a speed that is the double of the multiplexing speed, since the output signals are only available during one half of the clock period. During the other half, the readout busses are in their reference state (closing of switches 18, 19). At the input terminals side of amplifier 20 are located two capacitors C2 and feedback from the output of the amplifier 20 to each input terminal is provided either by a low resistance path through switches 21, 22 or through capacitors C1. The feedback through the capacitors C1 occurs when the amplifier is to amplify the signals on the busses 14, 15. In this state, the gain of the amplifier 20 is C2/C1. If C2/C1=(Cbus+Cs)/Cs, there is no attenuation due to the multiplexing technique. However, since the amplifier has to work at high bandwidth, it may be difficult to obtain enough gain at the required bandwidth level.

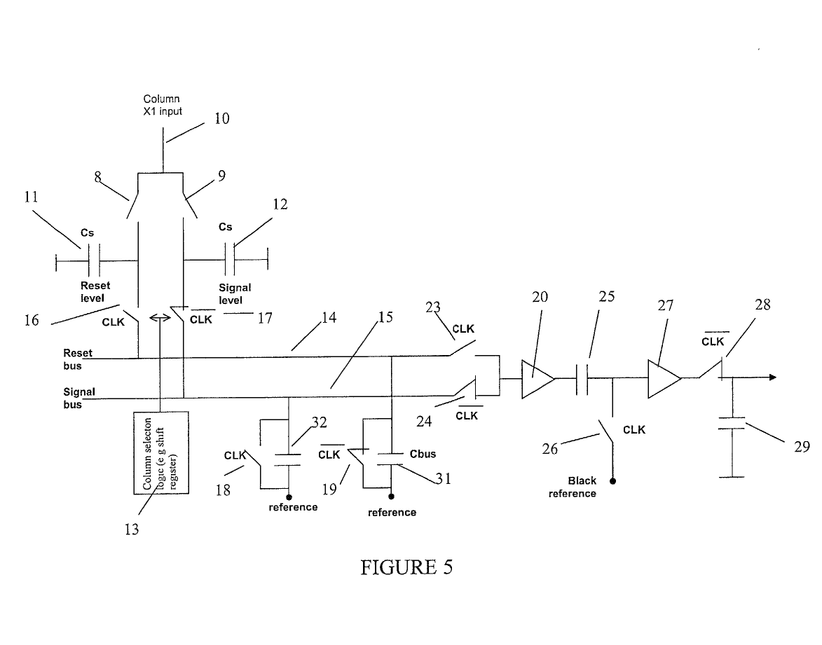

FIG. 5 shows another embodiment for the generation of the single-ended output signal from amplifier 20. The 2 busses 14, 15 (for the signal level and the reference level) are switched out of phase with each other. When one bus 14, 15 is in its reference state by closing the respective switch 18, 19, the second bus 15, 14 is carrying a signal and vice versa. To achieve this switches 16, 17 must also be operated out of phase with each other. “CLK” means a switch is closed when the clock is high (or low) and “CLK” means the switch is closed when the clock is low (or high) as delivered from a clock pulse circuit. The output amplifier 20, 27 contains a buffer 29 and a series capacitor 25. The difference between both signals presented on lines 14, 15 is stored on the capacitor 25. During a first part of a clock period, the one side of the capacitor is connected to the output offset level on one of the busses 14, 15 while the other side is connected to a reference signal level (corresponding to either the reset state or signal state) by closing switch 26. During the second part of the clock period, one side of the capacitor 25 is left floating (by opening switch 26) while the other side is connected to the other signal level (corresponding to either the signal or reset state) on bus 15, 14. On the floating side of the capacitor 25, the offset-error free output signal appears. This signal is buffered in a buffer 29 and stabilized during the entire clock period by a track & hold circuit including amplifier 27. The amplifier requirements for the circuit of FIG. 5 are less demanding because no gain is required for the same bandwidth (signal rate) specifications. The amplifier 20, 27 still has to work at the double frequency of the pixel rate, but it can work at unity gain.

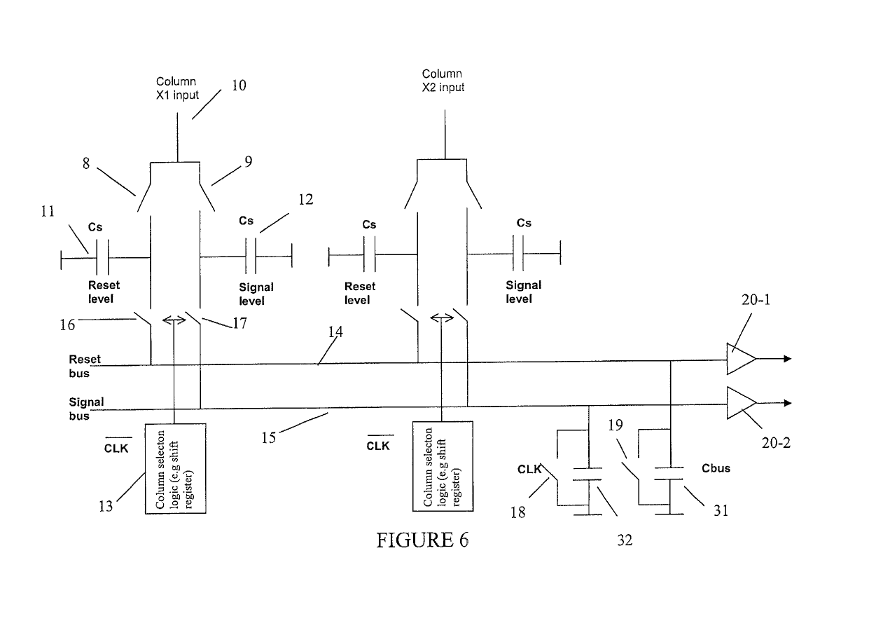

FIG. 6 shows a modification of the previous embodiments wherein the signals on both busses 14, 15 are directly fed to output amplifiers 20-1, 20-2—other components are as in FIG. 3. The difference between both signal outputs is free of signal offsets.

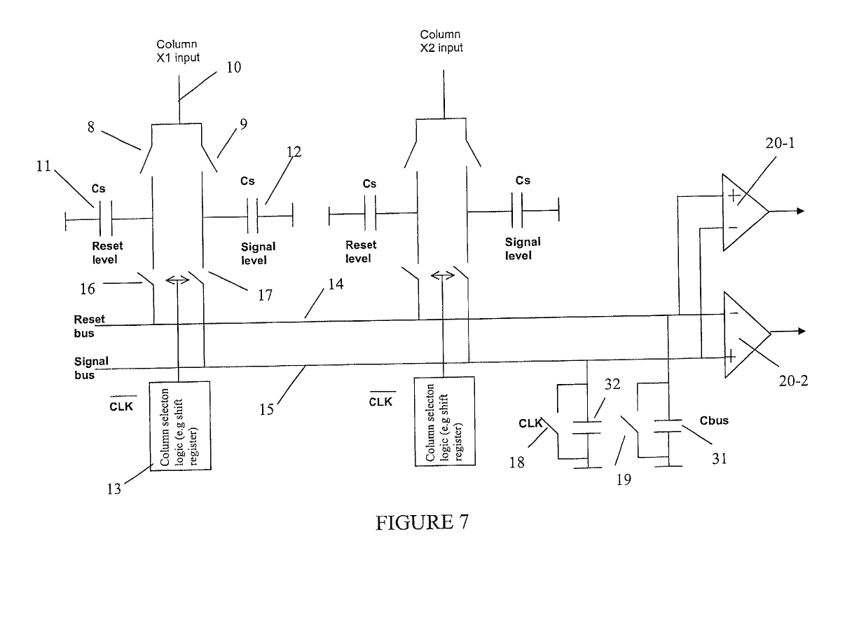

FIG. 7 shows a further embodiment of the present invention with true differential outputs. It contains 2 differential amplifiers 20-1, 20-2 of the type of FIG. 4 or 5 (amplifier 20). Other details are as in FIG. 3. The output is truly differential, both outputs move in different direction when they change.

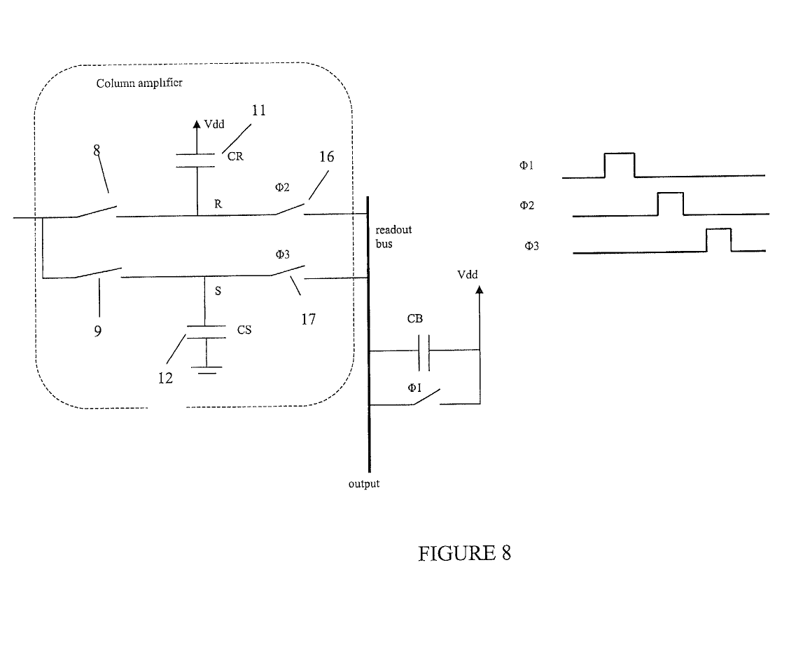

FIG. 8 shows another embodiment of the present invention in which a column amplifier is provided purely by passive components and switches. This is an example wherein the subtraction between the busses, 15 is done in a purely capacitive way, without much power consumption. After closing switch (Φ1, the charges QR, QS, QB on capacitors CR, CS and CB, respectively are (where Vdd is the voltage of a power source and VR is the voltage on the signal line connected to CR and VS is the voltage on the signal line connected to CS):

QR=CR*(Vdd-VR)

QS=CS*VS

QB=CB*Vdd

Let us assume that CR CB, then after pulsing Φ2, we can state that:

QB=CB(Vdd-VR/2)

And if Cs=½*CB, then after the (Φ3 pulse, the final output voltage VB will be:

VB=⅔*Vdd+(VS−VR)/3.

VB is a measure of the difference between VS and VR. In other configurations of this circuit, the offset can be adjusted or other gain factors can be achieved.

3. Signal Averaging (“Pseudo-Binning”)

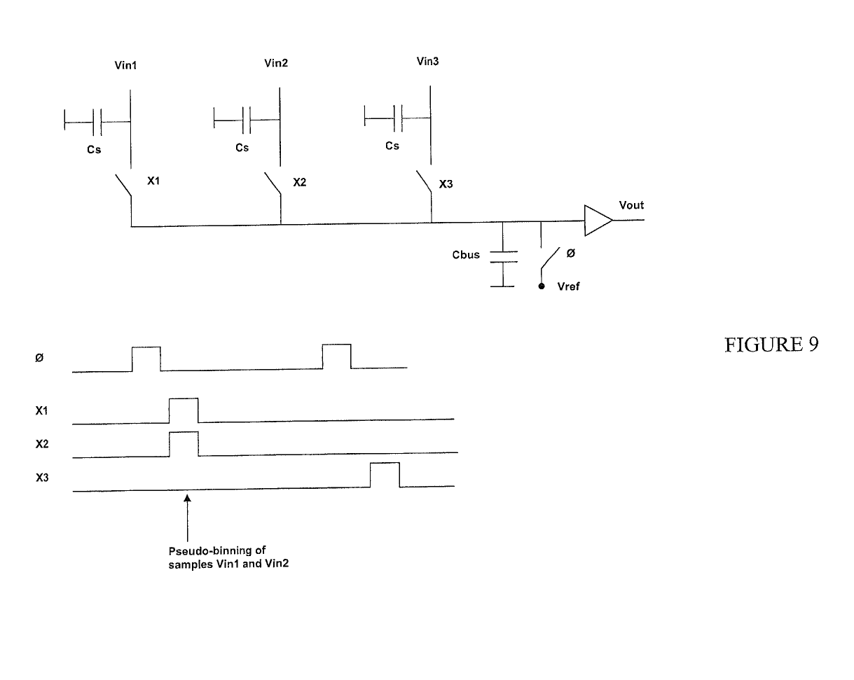

In image sensors, the switches used for multiplexing are controlled by a type of column pointer that scans through the columns of interest. This pointer can be generated by a shift register, a decoder or a combination of these. It is possible to select multiple storage nodes at the same time as shown schematically FIG. 9. It is further possible to combine a plurality of output signals from pixels. For example, a combination of the switches X1, X2, X3 are closed at the same time, e.g. two of these or all of these switches at one time. In this case, the average signal of the different storage nodes is placed on the readout bus. This averaging operation increases the signal-to-noise ratio. Alternatively, other groupings or combinings of signals are included within the scope of the present invention. For instance instead of summing signals from different columns (i.e. on a row or part of a row), the signals from pixels on one column or a part of a column may be summed together. Yet another possibility is to sum together the outputs from a groups of pixels from parts of different columns and rows, e.g. from an area of a pixel array. In all these cases the amplitudes of the signals are combined in some way, e.g. summed together while the noise is only quadratically summed (RMS). For example, if two identical signals are averaged, the signal amplitude doubles and the noise only multiplies by the square root of 2. The S/N increases by a factor 1.4 (=sqrt(2)). This operation approximates true “charge binning” in charge-domain devices like Charge-Coupled Devices. In these devices however, the signal is added while the noise remains the same. The averaging operation of circuits in accordance with the present invention are therefore called “pseudo-bilning”.

The multiplexer gain factor is higher for a pseudo-binning operation than for multiplexing of a single storage node. For example, if all capacitances are equal (equal Cs and Cbus, and all storage nodes have identical capacitance), the gain is 0.5 when only one storage node is read out, and 0.66 when two nodes are read out together, in pseudo-binning mode. This is beneficial, because the pseudo-binning mode will typically be applied when the signal amplitude is low.

Since the signal to noise ratio is increased by this operation and the signal gain is higher, this pseudo-binning operation is an interesting feature for low signal (or light) levels (with a low signal to noise ratio).

4. Applications in Imagers

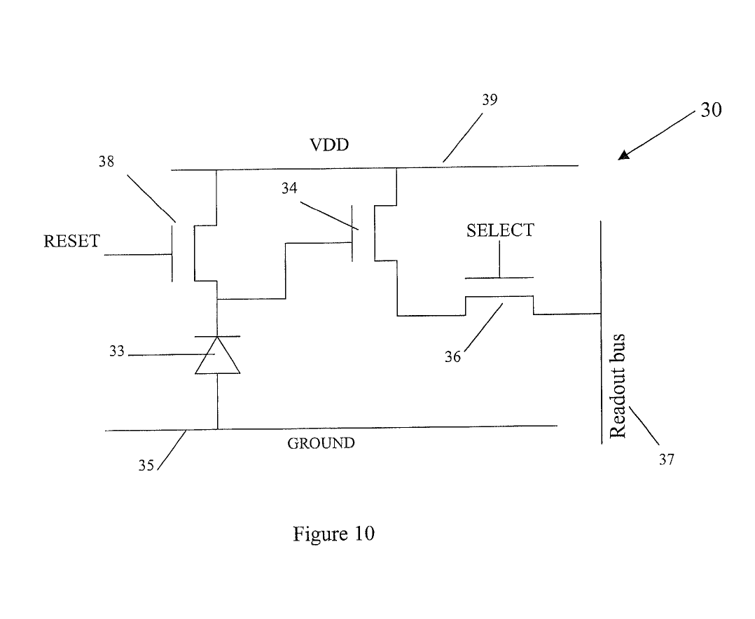

A non-limiting pixel structure 30 suitable for use with the present invention is shown in FIG. 10. It comprises a radiation sensitive element 33 and an amplifying circuit 34, hence it is an active pixel. The radiation sensitive element 33 may be a photoreceptor which yields current or charge depending upon the incident light intensity. Such a radiation sensitive element 33 may be a photodiode, a photo bipolar junction transistor, a photo-gate or similar. The amplifying circuit 34 may comprise a transistor, for example such as a bipolar transistor but more preferably an MOS transistor such as a MOSFET transistor or may comprise several such transistors forming an amplifier or any other sort of amplifier. As shown, the gate of the amplifying transistor is connected to one output of the radiation sensitive element 33. One main electrode of the amplifying transistor is connected to a voltage source line 39. By main electrode is to be understood one of source or drain. The pixel 30 also comprises a selection device 36 with which the output of each pixel 30 may be connected to a readout bus 37. The selection device 36 may be a switching element. The selecting device 36 may be a transistor such as a bipolar transistor or a MOSFET transistor or similar. The other main electrode of the amplifying transistor is connected to one main electrode of the selecting transistor. The other main electrode of the selecting transistor is connected to the readout bus 37. The gate of the selecting transistor is connected to a selecting bus. Lines 39 and 35 provide voltage sources to drive the circuit elements 34, 36. The radiation sensitive element 33 is connected between the voltage source lines 39, 35 such that a change of resistance of the radiation sensitive device (caused by incident light intensity) changes the current flowing through it. In addition a reset device 38 is provided for resetting the pixel between selections by the selection device 36. The reset device 38 may be placed in series with the radiation sensitive device 33. The reset device 38 may be a switching element. The switching element may be a transistor such as a bipolar transistor but is more preferably and MOS transistor such as a MOSFET transistor. One main electrode of the reset transistor is connected to one of the voltage source lines 39. The other main electrode is connected to the radiation sensitive element 33. The gate of the reset transistor is connected to a reset bus.

Pixels can be assembled in a geometrical array, for example in rows and columns but also in other ways, e.g. in a polar array of a log polar array. The complete array is preferably made on one chip. Preferably, the pixel array and all readout electronics is fabricated on this one chip. Preferably, the pixels are active pixels, i.e. they include their own local amplifying element. The present invention uses charge transfer to transfer the input signal to a common output line. Where column is referred to in this text it is understood that the array could be rotated through 90° so that columns become rows and vice versa without a functional alteration.

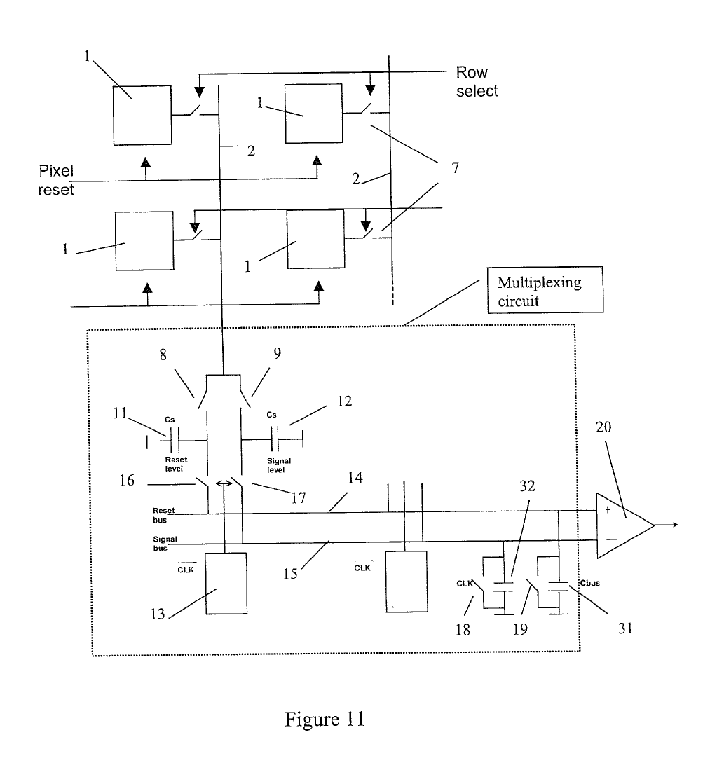

FIG. 11 shows an embodiment of this circuit, illustrated with a 2×2 pixel array of pixels 30 as shown in FIG. 10 with a readout arrangement as shown in FIG. 3. Like other techniques, this embodiment uses a ‘double sampling’ technique, this means that the pixel is read out twice. One readout refers to the pixel output level in the dark (referred to above with respect to FIG. 3 as the reset level), and the other readout refers to the pixel output after illumination (referred to above with respect to FIG. 3 as the signal level). Both these signals are influenced in the same way by offset variations in the components of the pixel. By consequence, the difference between both signals is free of pixel offset variations. This difference is generated at the amplifier 20 as the two different signals are placed on the inputs of this amplifier which operates as a differential amplifier. Hence, its output is proportional to the difference between the dark and illumination values. Although FIG. 11 has been shown with the multiplexing circuit of FIG. 3, any of the multiplexing circuits described above may be used with such a pixel array.

While the invention has been shown and described with reference to preferred embodiments, it will be understood by those skilled in the art that various changes or modifications in form and detail may be made without departing from the scope and spirit of this invention.

What is claimed is:

1. A multiplexing circuit comprising:
a series of signal input nodes
a series of first memory elements for storing a signal level on the corresponding signal input nodes
at least a first output node comprising a second memory element
a series of first switching elements, each first switching element being connected to a first memory element on one side and a first output node on the other side, and
a second switching element to bring the first output node in a known state.

2. The multiplexing circuit according to claim 1, wherein the first switching elements have an open and closed state and in the closed state the first switching elements share a charge stored in the corresponding first memory element with the second memory element.

3. The multiplexing circuit according to claim 2, further comprising an output amplifying element and an input to the amplifying element is connected to a common point between the first and second memory elements.

4. The multiplexing circuit according to claim 2, wherein the output amplifying element is a transistor.

5. The multiplexing circuit according to claim 1, wherein at least one of the first and second memory elements is a capacitor.

6. The multiplexing circuit according to claim 1, wherein the first and second switching elements have open and closed states, further comprising a timing circuit, the timing circuit providing timing signals to the first and second switching elements to switch each first and second switching element to an open or closed state, and the timing circuit being adapted to drive the first and second switching elements so that a first switching element is not closed at the same time as a second switching element is closed.

7. The multiplexing circuit according to claim 1, further comprising: two output nodes, the second output node being connected to a third memory element and a third switching element to bring the second output node in a known state, each input signal node comprising the first and a fourth memory element, and a fourth switching element being connected to the fourth memory element on one side and the second output node on the other side.

8. The multiplexing circuit according to claim 7, wherein a first signal is stored in the first memory element,
a second signal is stored in the second memory element,
and a timing circuit is provided for driving the first to fourth switching elements such that the charge on the first memory element is shared with the second memory element, the charge on the fourth memory is shared with the third memory element, the second switching element brings the first output node in the known state, and the third switching element brings the second output node in a known state.

9. The multiplexing circuit according to claim 7, wherein the first and second outputs nodes are connected to inputs of an amplifying element.

10. A pixel and readout circuitry therefor adapted for integration in an imaging device, comprising
a radiation sensitive element able to produce an electrical signal indicative of the amount of radiation picked up by that pixel,
a signal input node, a signal level being obtained from the radiation sensitive element,
a first memory element for storing the signal level on the corresponding signal input node
at least a first output node comprising a second memory element
a first switching element being connected to the first memory element on one side and the first output node on the other side, and
a second switching element to bring the first output node in a known state.

11. The pixel and readout circuitry according to claim 10, wherein the first switching elements have an open and closed state and in the closed state the first switching elements share a charge stored in the corresponding first memory element with the second memory element.

12. The pixel and readout circuitry according to claim 11, further comprising an output amplifying element and an input to the amplifying element is connected to a common point between the first and second memory elements.

13. The pixel and readout circuitry according to claim 11, wherein the output amplifying element is a transistor.

14. The pixel and readout circuitry according to claim 10, wherein at least one of the first and second memory elements is a capacitor.

15. The pixel and readout circuitry according to claim 10, wherein the first and second switching elements have open and closed states, further comprising a timing circuit, the timing circuit providing timing signals to the first and second switching means to switch each first and second switching element to an open or closed state, and the timing circuit is adapted to drive the first and second switching elements so that a first switching element is not closed at the same time as a second switching element is closed.

16. The pixel and readout circuitry according to claim 10, further comprising two output nodes, the second output node being connected to a third memory element and a third switching element to bring the second output node in a known state, each input signal node comprises the first and a fourth memory element, and a fourth switching element being connected to the fourth memory element on one side and the second output node on the other side.

17. The pixel and readout circuitry according to claim 16, wherein a first signal is stored in the first memory element, a second signal is stored in the second memory element, and a timing circuit is provided for driving the first to fourth switching elements such that the charge on the first memory element is shared with the second memory element, the charge on the fourth memory is shared with the third memory element, the second switching element brings the first output node in the known state, and the third switching element brings the second output node in a known state.

18. The pixel and readout circuitry according to claim 16, wherein the first and second outputs nodes are connected to inputs of an amplifying element.

19. An array of pixels for integration in an imaging device, each pixel comprising a radiation sensitive element able to produce an electrical signal indicative of the amount of radiation picked up by that pixel, further comprising:
a signal input node, a signal level being obtained from the radiation sensitive element,
a first memory element for storing the signal level on the corresponding signal input node
at least a first output node comprising a second memory element
a first switching element being connected to the first memory element on one side and the first output node on the other side, and
a second switching element to bring the first output node in a known state.

20. The array according to claim 19 wherein the pixels are arranged in rows and columns and means for summing the signals levels from a plurality of pixels.

21. A method for reading out a solid state imaging device having a group of pixels, each pixel comprising a radiation sensitive element, the method comprising the following steps:
reading out the signal of a pixel brought in a first state and storing the corresponding charge in a first memory element
bring the output line into a reference state
sharing the charge on the first memory element with a second memory element on an output line, and
repeating these steps for at least part of the pixels of the imaging device.
